(19) United States
(12) Patent Application Publication
(10) Pub. No.: US 2025/0094175 A1
(43) Pub. Date: Mar. 20, 2025

(54) METHOD AND APPARATUS FOR REBOOTING FUNCTIONAL COMPONENT ON SYSTEM ON CHIP AND DEVICE

(71) Applicant: XG TECH PTE. LTD., Singapore (SG)

(72) Inventor: Jianfeng YU, Singapore (SG)

(73) Assignee: XG TECH PTE. LTD., Singapore (SG)

(21) Appl. No.: 18/962,151

(22) Filed: Nov. 27, 2024

(30) Foreign Application Priority Data
Aug. 16, 2024 (CN) 2024411131899.0

(51) Int. Cl. G06F 9/4401; G06F 15/78

(52) U.S. Cl. CPC G06F 9/4401; G06F 15/7807

(57) ABSTRACT

A method for rebooting functional components on a system on chip includes: performing access isolation on a first bus interface of the first functional component and a shared bus in response to detecting that a state of the first functional component on the system on chip is a first state; wherein the shared bus is a bus shared by at least two operating systems on the system on chip; rebooting the first functional component to transition the first functional component from the first state to a second state; and performing access dis-isolation on the first bus interface of the first functional component and a shared bus. According to the embodiments of the present disclosure, the first functional component with anomalies is rebooted and normal access by the first functional component and the shared bus is restored, effectively improving overall stability of the system on chip of multiple operating systems.

### CROSS-REFERENCE TO RELATED APPLICATION

The present disclosure claims priority to Chinese Patent Application No. 202411131899.0, filed on Aug. 16, 2024, entitled “method and apparatus for rebooting a functional component on a system on chip and a device”, which is incorporated herein by reference in its entirety.

### TECHNICAL FIELD

The present disclosure relates to an integrated circuit technology, and more particularly to a method and apparatus for rebooting a functional component on a system on chip and a device.

### BACKGROUND

In a case where multiple operating systems are operated in a system on chip (SoC), the software of any one of the multiple operating systems may be abnormal, and it is easy to perform unexpected operation on the hardware functional component in the system on chip, resulting in anomalies in the hardware functional component or anomalies in the hardware functional component due to its own reasons. The anomalies in the hardware functional component may easily affect operation of other operating systems in the system on chip.

### SUMMARY

In the embodiments of the present disclosure, there are provided a method and apparatus for rebooting a functional component on a system on chip and a device, which may improve the overall stability of the system on chip while preventing affecting the operation of other operating systems.

According to a first aspect of the present disclosure, there is provided a method for rebooting a functional component on a system on chip, including: performing access isolation on a first bus interface of a first functional component on the system on chip and a shared bus shared by at least two operating systems on the system on chip in response to detecting that a state of the first functional component is a first state; rebooting the first functional component to transition the first functional component from the first state to a second state; and performing access dis-isolation on the first bus interface of the first functional component and the shared bus.

According to a second aspect of the present disclosure, there is provided an apparatus for rebooting a functional component on a system on chip, including: a first processing module configured for performing access isolation on a first bus interface of the first functional component on the system on chip and a shared bus shared by at least two operating systems on the system on chip in response to detecting that a state of the first functional component is a first state a second processing module configured for rebooting the first functional component to transition the first functional component from the first state to a second state; and a third processing module configured for performing access dis-isolation on the first bus interface of the first functional component and the shared bus.

According to a third aspect of the present disclosure, there is provided a computer-readable storage medium storing a computer program thereon for performing a method for rebooting a functional component on a system on chip according to any one of the embodiments of the present disclosure.

According to a fourth aspect of the present disclosure, there is provided an electronic device, including: a processor; a memory for storing the processor-executable instructions; wherein the processor is configured to read the executable instructions from the memory and execute the instructions to implement a method for rebooting a functional component according to any one of the above embodiments of the present disclosure; or, the electronic device includes the apparatus for rebooting a functional component on a system on chip according to any one of the embodiments of the present disclosure described above.

According to a fifth aspect of the present disclosure, a there is provided computer program product, which, when instructions in the computer program product are executed by a processor, makes the processor to perform a method for rebooting a functional component on a system on chip as provided by any one of the above embodiments of the present disclosure.

Based on the method and apparatus for rebooting a functional component on a system on chip and a device provided by the above-mentioned embodiments of the present disclosure, in a case where it is detected that a state of a first functional component on the system on chip is a first state (i.e., an abnormal state), access isolation may be performed on a first bus interface of the first functional component and a shared bus to prevent the first functional component from continuing to access the shared bus, and an unexpected access by the abnormal first functional component to the shared bus may be avoided, thereby refraining from adverse effects on other operating systems and other functional components connected on the shared bus. Thus, in a case of access isolation, further rebooting the first functional component so that the first functional component may transition from an abnormal state to a second state (i.e., a normal operating state); after the first functional component returns to normal, access dis-isolation is performed on the first bus interface of the first functional component and the shared bus, so that the first functional component may access the shared bus normally, and the first functional component with anomalies is rebooted and normal access by the first functional component to the shared bus is restored on the basis of not affecting operation of other operating systems of the shared bus, effectively improving overall stability of the system on chip with multiple operating systems. For example, the system on chip is a cabin-driving integrated system, on which at least two operating systems, such as an operating system for an intelligent cabin and an operating system for an intelligent driving, are simultaneously operated. In a case where any one operating system anomaly causes anomalies in one or more functional components on the system on chip, by means of the method for rebooting the functional component of the embodiment of the present disclosure, the abnormal functional component may be restored to a normal operating state without affecting the operation of the other operating system, ensuring the stability of the other operating system.

### BRIEF DESCRIPTION OF THE DRAWINGS

FIG. 1 is an example application scenario of a method for rebooting a functional component on a system on chip according to an embodiment of the present disclosure;

FIG. 2 is a schematic flow diagram showing a method for rebooting a functional component on a system on chip according to an example embodiment of the present disclosure;

FIG. 3 is a schematic flow diagram showing a method for rebooting a functional component on a system on chip according to another example embodiment of the present disclosure;

FIG. 4 is a schematic flow diagram showing a method for rebooting a functional component on a system on chip according to yet another example embodiment of the present disclosure;

FIG. 5 is a schematic flow diagram showing a method for rebooting a functional component on a system on chip according to yet still another example embodiment of the present disclosure;

FIG. 6 is a schematic flow diagram showing a method for rebooting a functional component on a system on chip according to yet another example embodiment of the present disclosure;

FIG. 7 is a schematic flow diagram showing a method for rebooting a functional component on a system on chip according to yet still another example embodiment of the present disclosure;

FIG. 8 is a schematic flow diagram showing a method for rebooting a functional component on a system on chip according to yet another example embodiment of the present disclosure;

FIG. 9 is a schematic flow diagram showing a method for rebooting a functional component on a system on chip according to yet still another example embodiment of the present disclosure;

FIG. 10 is a schematic flow diagram showing a method for rebooting a functional component on a system on chip according to yet another example embodiment of the present disclosure;

FIG. 11 is an overall schematic flow diagram showing a method for rebooting a functional component on a system on chip according to an example embodiment of the present disclosure;

FIG. 12 is a schematic structural diagram showing an apparatus for rebooting a functional component on a system on chip according to an example embodiment of the present disclosure;

FIG. 13 is a schematic structural diagram showing an apparatus for rebooting a functional component on a system on chip according to another example embodiment of the present disclosure;

FIG. 14 is a schematic structural diagram showing an apparatus for rebooting a functional component on a system on chip according to yet another example embodiment of the present disclosure;

FIG. 15 is a schematic structural diagram showing an apparatus for rebooting a functional component on a system on chip according to yet still another example embodiment of the present disclosure;

FIG. 16 is a schematic structural diagram showing an apparatus for rebooting a functional component on a system on chip according to yet another example embodiment of the present disclosure;

FIG. 17 is a structural block diagram showing an apparatus for rebooting a functional component on a system on chip according to an example embodiment of the present disclosure;

FIG. 18 is a schematic structural diagram showing an access isolation unit 7110 according to an example embodiment of the present disclosure;

FIG. 19 is a schematic structural diagram showing an access isolation unit 7110 according to another example embodiment of the present disclosure;

FIG. 20 is a schematic structural diagram showing an access isolation unit 7110 according to yet another example embodiment of the present disclosure; and

FIG. 21 is a schematic structural diagram showing an electronic device according to an embodiment of the present disclosure.

### DETAILED DESCRIPTION

In order to explain the present disclosure, example embodiments of the present disclosure will be described in detail below with reference to the accompanying drawings. It is apparent that the described embodiments are only a part of the embodiments of the present disclosure, not all of them, and it is to be understood that the present disclosure is not limited to the example embodiments.

It should be noted that the relative arrangement of parts and steps, numerical expressions and numerical values set forth in these examples do not limit the scope of the present disclosure unless specifically stated otherwise.

### SUMMARY OF THE PRESENT DISCLOSURE

In implementing the present disclosure, it has discovered that in a case where multiple operating systems are operated in a system on chip (SoC, also referred to as System-on-a-Chip, or Chip for short), the software of any one of the multiple operating systems may be abnormal, which will easily perform unexpected operation on the hardware functional component in the system on chip, resulting in anomalies in the hardware functional component or anomalies in hardware functional component due to its own reasons. The anomalies in the hardware functional component may easily affect operation of other operating systems in the system on chip.

### Example Overview

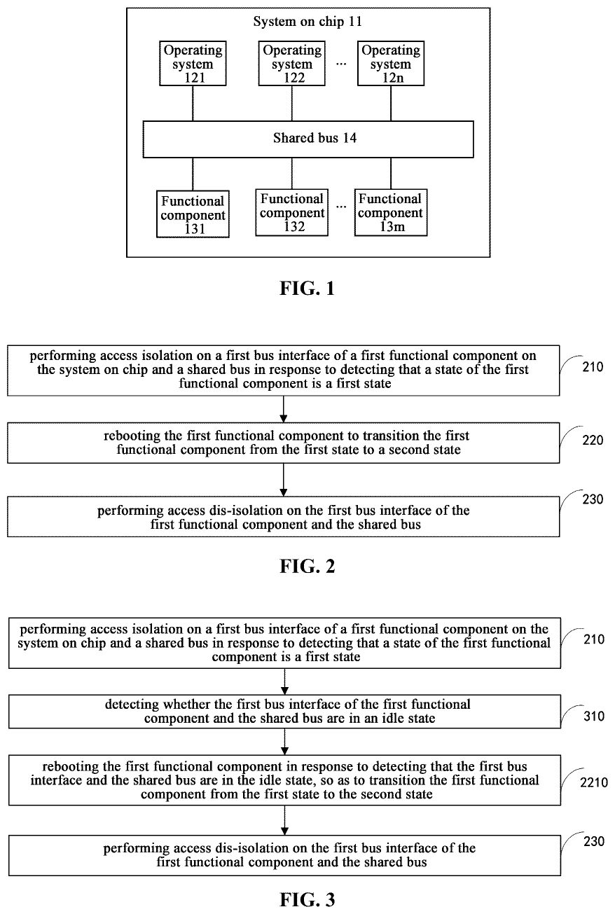

FIG. 1 is an example application scenario of a method for rebooting a functional component on a system on chip according to an embodiment of the present disclosure. As shown in FIG. 1, n operating systems may be operated in a system on chip 11, including an operating system 121, an operating system 122, . . . , an operating system 12n, n being an integer greater than one. The system on chip 11 may further include m functional components, including a functional component 131, a functional component 132, . . . , and a functional component 13m, which each may be used for executing tasks of respective operating systems, and m is a positive integer. The functions of any two functional components may be the same or different. For example, the functional component may include a hardware Intellectual Property (IP) core such as a Graphics Processing Unit (GPU) component, Image Signal Processing (ISP) component, Universal Serial Bus (USB) component, peripheral component interconnect express (PCIE) component, Neural network Processing Unit (NPU) component. The shared bus 14 is a bus shared by the operating systems. That is, the system on chip 11, when operating various operating systems, may interact with various functional components via the shared bus 14 to execute corresponding instructions via the functional components to complete the tasks of corresponding functions. Taking a mobile device with intelligent driving and an intelligent cabin (such as a vehicle, an unmanned aerial vehicle, etc.) as an example, the operating system 121 may be an operating system corresponding to the intelligent cabin, i.e., the system on chip 11 executes instructions of an algorithm or model related to the intelligent cabin by operating the operating system 121 to realize a related function of the intelligent cabin. For example, the system on chip 11 executes instructions of an intelligent cabin perception algorithm by operating the operating system 121, and perceives the interior of the cabin based on environmental data (such as an image) in the cabin acquired by a sensor (such as a camera) in the cabin to obtain a perception result in the cabin. The system on chip 11 executes instructions of intelligent driving-related algorithms or models by operating an operating system 122 to perform functions such as perception, planning, control of intelligent driving. The intelligent driving function of the mobile device may be realized by acquiring the external environment data, sensing the external environment, making planning and controlling based on the sensed result of the external environment through sensor on the mobile device. With the method for rebooting a functional component on a system on chip of the embodiments of the present disclosure, in a case where it is detected that the state of any functional component on the system on chip 11 (referred to as a first functional component, e.g., functional component 131, functional component 132, etc.) is a first state (i.e., an abnormal state), access isolation may be performed on the first bus interface of the first functional component and the shared bus 14 to prevent the abnormal first functional component from outputting an access request to the shared bus 14, thereby refraining from generating an unexpected operation. After performing access isolation on the first bus interface of the first functional component and the shared bus 14, the first functional component may be rebooted to transition the first functional component from the abnormal state to the second state (i.e., a normal state, or a normal operating state). At this time, since the first bus interface and the shared bus 14 are in an access isolation condition, although the first functional component transitions to the normal state, the shared bus 14 cannot be accessed yet. Thus, it is required to performed access dis-isolation on the first bus interface of the first functional component and the shared bus, so that the first functional component may access the shared bus normally 14, thereby effectively improving overall stability of the system on chip 11 with multiple operating systems by rebooting the first functional component with anomalies and restoring normal access by the first functional component to the shared bus 14 without affecting operation of other operating systems connected to the shared bus 14.

The method for rebooting a functional component on a system on chip according to the embodiments of the present disclosure is not limited to being applied to an integrated (i.e., cabin-driving integrated) scenario of intelligent driving and an intelligent cabin, but may also be applied to any other scenario capable of simultaneously operating at least two operating systems on a single system on chip, such as a scenario of a terminal device such as a mobile phone, a tablet, a computer, etc.

### Example Method

FIG. 2 is a schematic flow diagram showing a method for rebooting a functional component on a system on chip according to an example embodiment of the present disclosure. Specifically, the present embodiment may be applied to an electronic device, such as a System-on-a-Chip (i.e., a system on chip) of a vehicle-mounted computing platform. As shown in FIG. 2, the method according to the embodiment of the present disclosure may include the following steps:

step 210: performing access isolation on a first bus interface of a first functional component on the system on chip and a shared bus in response to detecting that a state of the first functional component is a first state.

The shared bus is a bus shared by at least two operating systems on the system on chip. The system on chip may be a System-on-a-Chip capable of operating at least two operating systems simultaneously in any scenario. The first functional component may be any functional component on a system on chip. For example, the first functional component may be any one of GPU, ISP, NPU, USB, PCIE, etc. The state of the first functional component may include a first state and a second state. The first state is an abnormal state. The second state is a normal state. In practice, the state of the first functional component may also include a reset state. Access isolation refers to isolating access by the first functional component to the shared bus, i.e., preventing (or terminating) an access request of the first functional component from being transmitted to the shared bus, and preventing the abnormal first functional component from initiating an unexpected operation on the shared bus to affect other functional components and operating systems on the shared bus.

In some alternative embodiments, the first functional component may correspond to a hardware module of any operating system on the system on chip. For example, in a case where anomalies occur in the software executed by an operating system on a system on chip, which is using a first functional component to execute a corresponding task, an unexpected operation may be performed on the first functional component due to the anomalies in the operating system. For example, an unexpected configuration operation is performed on the first functional component, resulting in the anomalies in the first functional component. When the anomalies in the first functional component are detected, access isolation may be performed on the first bus interface of the first functional component and the shared bus to refraining from affecting the normal operation of the shared bus by the anomalies in the operating system, and thus avoiding affecting the normal use of the shared bus by other operating systems. An abnormal operating system may also be restored to the normal state in a timely manner.

In some alternative embodiments, the first bus interface of the first functional component is a bus interface through which the first functional component is capable of actively initiating an access request to the shared bus. For example, in a case where a Master bus interface and a Slave bus interface are supported, the first bus interface of the first functional component is the Master interface of the first functional component. That is, the first functional component initiates an access request to the shared bus, and receives response information by the shared bus via the Master bus interface. The Slave interface of the first functional component is used for the shared bus to actively initiate an access request to the first functional component. The first functional component receives the access request by the shared bus and returns the response information to the shared bus via the Slave interface.

In some alternative embodiments, the state of the first functional component may be detected in any implementable manner. For example, it is detected whether the state of the first functional component is an abnormal state by a detection function carried in the first functional component, and if the abnormal state of the first functional component is detected, an abnormal state signal is fed back to an apparatus for performing the method according to an embodiment of the present disclosure, and the apparatus according to the embodiment of the present disclosure may determine that the state of the first functional component on the system on chip is detected as the abnormal state. For another example, it may be determined whether the state of the first functional component is the abnormal state by detecting the execution of the assigned task by the first functional component. If a task execution result is not obtained for the task assigned to the first functional component for a long time, it may be determined that the state of the first functional component is the abnormal state. For example, an ISP functional component may be determined as being in the abnormal state if the execution result for the assigned signal processing task has not fed back for a long time. The specific manner of detecting the abnormal state of the first functional component is not limited thereto.

In some alternative embodiments, access isolation may be performed on the first bus interface of the first functional component and the shared bus by any implementable access isolation means. For example, access isolation is achieved by a bus switch controlling the opening and closing of a transmission path between the first bus interface and the shared bus. For another example, access isolation is achieved by setting a forwarding controller between the first bus interface and the shared bus to control whether the access request by the first functional component is forwarded to the shared bus. The specific access isolation is not limited thereto.

Step 220: rebooting the first functional component to transition the first functional component from the first state to a second state.

The second state is a normal state (or referred to as an operating state and a normal operating state).

In some alternative embodiments, the first functional component may be rebooted according to the rebooting mode actually supported by the first functional component. For example, a rebooting of the first functional component is triggered by a reset signal or other means. The first functional component is restored from the abnormal state to the normal state by rebooting the first functional component.

Step 230: performing access dis-isolation on the first bus interface of the first functional component and the shared bus.

Access dis-isolation between the first bus interface of the first functional component and the shared bus refers to access by the first functional component to the shared bus being no longer prevented to ensure that an access request by the first functional component may be normally transmitted to the shared bus.

In some alternative embodiments, access dis-isolation may be performed on the first bus interface of the first functional component and the shared bus according to the dis-isolation means corresponding to the access isolation means described above. For example, in a case where the access isolation is achieved by disconnecting the transmission path between the first bus interface and the shared bus via the bus switch, access dis-isolation is achieved by connecting the transmission path between the first bus interface and the shared bus by closing the bus switch. In a case where access isolation is achieved by terminating forwarding an access request of a first functional component to the shared bus by means of a forwarding controller, access dis-isolation may be achieved by starting forwarding the access request of the first functional component and the shared bus by means of the forwarding controller.

By the method for rebooting functional components on a system on chip provided according to the embodiment of the present disclosure, in a case where it is detected that a state of a first functional component on the system on chip is the first state (i.e., an abnormal state), access isolation may be performed on a first bus interface of the first functional component and a shared bus to prevent the first functional component from continuing to access the shared bus, and thus an unexpected access by the first functional component with anomalies to the shared bus may be prevented, thereby preventing adverse effects on other operating systems and other functional components connected on the shared bus. Thus, in a case of access isolation, rebooting the first functional component so that the first functional component may transition from the first state (i.e., abnormal state) to the second state (i.e., the normal operating state); after the first functional component returns to normal, access dis-isolation may be performed on the first bus interface of the first functional component and the shared bus, so that the first functional component may access the shared bus normally, thereby effectively improving overall stability of the system on chip with multiple operating systems by rebooting the first functional component with anomalies and restoring normal access by the first functional component to the shared bus without affecting operation of other operating systems connected to the shared bus. For example, the system on chip is a cabin-driving integrated system, and at least two operating systems, such as an operating system for an intelligent cabin and an operating system for an intelligent driving, are simultaneously operated on one system on chip, and in a case where any one operating system anomaly causes anomalies in one or more functional components on the system on chip, by the method for rebooting the functional component on the system on chip according to the embodiment of the present disclosure, the abnormal functional component may be restored to a normal operating state without affecting the operation of the other operating system, ensuring the stability of the other operating system.

In some alternative embodiments, on the basis of the above-described embodiment of FIG. 2, the step 210 of performing access isolation on a first bus interface of a first functional component and the shared bus may include: disconnecting a transmission path between the first bus interface and the shared bus to prevent an access request of the first functional component from being transmitted to the shared bus.

In some alternative embodiments, a transmission path between the first bus interface and the shared bus may be disconnected by a bus switch or other means, so that the access request of the first functional component output by the first bus interface cannot be transmitted to the shared bus, so as to prevent the access request of the first functional component from being transmitted to the shared bus.

In the present embodiment, by disconnecting the transmission path between the first bus interface and the shared bus, access isolation may be performed on the first functional component and the shared bus to prevent the first functional component initiating unexpected access to the shared bus, thereby ensuring the normal operation of other functional components and the operating system, and improving the overall stability of the system.

In some alternative embodiments, on the basis of the above-described embodiment of FIG. 2, the step 210 of performing access isolation on a first bus interface of a first functional component and a shared bus may include: terminating forwarding of an access request of the first functional component to the shared bus.

In a case where the access of the first functional component to the shared bus is realized by forwarding the access request, if it is detected that the state of the first functional component is an abnormal state, the access isolation function of the first bus interface and the shared bus may be achieved by terminating forwarding the access request of the first functional component to the shared bus.

In the present embodiment, by terminating forwarding the access request by the first functional component and the shared bus, the access isolation between the first functional component and the shared bus may be achieved to prevent the first functional component initiating unexpected access to the shared bus, thereby ensuring the normal operation of other functional components and the operating system, and improving the overall stability of the system.

FIG. 3 is a schematic flow diagram showing a method for rebooting a functional component on a system on chip according to another example embodiment of the present disclosure.

In some alternative embodiments, on the basis of the embodiment of FIG. 2 described above, as shown in FIG. 3, after performing access isolation on the first bus interface of the first functional component and the shared bus, the method according to the embodiment of the present disclosure may further include:

step 310: detecting whether the first bus interface of the first functional component and the shared bus are in an idle state.

Whether the first bus interface of the first functional component and the shared bus are in an idle state refers to whether there is an access request not being responded to by the shared bus, i.e., whether all the access requests initiated by the first functional component to the shared bus are responded to before the access isolation, and the access requests being responded refers to receiving response information returned by the shared bus. If there is at least one access request has not been responded to, it is indicated that the first bus interface and the shared bus are not in an idle state but are still in interaction, and not in an idle state. If it is determined that there are no unresponsive access requests, the first functional component does not initiate a new access request due to access isolation, which indicates that the first bus interface and the shared bus are in the idle state.

In some alternative embodiments, an access request initiated by the first functional component to the shared bus refers to a request by the first functional component to access another functional component or operating system via the shared bus to be in information interaction with the other functional components or operating systems. The access request may include commands and/or data sent by the first functional component to other functional components or operating systems to be accessed. Taking intelligent driving as an example, an access request initiated by the first functional component may include, for example, sensor data, sensed result data, vehicle state information, etc. sent to other functional components or operating systems. The access requests initiated by different functional components may be different in different scenarios.

In some alternative embodiments, it may be determined whether the access request is responded to by caching the access request transmitted by the first functional component and the response information returned by the shared bus, and thus detecting whether the first bus interface of the first functional component and the shared bus are in an idle state according to the responded condition of the access request.

In some alternative embodiments, in a case where access isolation are performed on the first bus interface and the shared bus, it may remain capable of receiving response information returned by the shared bus in order to detect whether the first bus interface of the first functional component and the shared bus are in the idle state. For example, in a case where access isolation is performed via a bus switch, a controller of the bus switch may be connected to the first bus interface and the shared bus via a bypass bus, and in a case of disconnecting the transmission path between the first bus interface and the shared bus via the bus switch, it is ensured that the response information of the shared bus may be transmitted to the controller of the bus switch, so that the controller may determine whether the first bus interface of the first functional component and the shared bus are in an idle state according to the transmitted access request and the response information. The response information received by the controller may or may not be forwarded to the first functional component. The controller may also return a confirmation signal to the shared bus to confirm the response information being received. For another example, in a case where the access isolation is performed via the forwarding controller, the forwarding controller may keep receiving response information returned by the shared bus, and thus may further determine whether the first bus interface of the first functional component and the shared bus are in an idle state based on the transmitted access request and the response information. After receiving the response information, the forwarding controller may also return a confirmation signal to the shared bus to confirm the reply message being received. In practice, access isolation and detection of whether the first bus interface of the first functional component and the shared bus are in an idle state may also be performed by other means, and the embodiments of the present disclosure are not limited thereto.

The step 220 of rebooting the first functional component to transition the first functional component from the first state to a second state may include:

step 2210: rebooting the first functional component in response to detecting that the first bus interface and the shared bus are in the idle state, so as to transition the first functional component from the first state to the second state.

Here, the specific operation of rebooting the first functional component may be referred to the aforementioned embodiment, and will not be described in detail.

In the present embodiment, in a case where it is determined that the first bus interface and the shared bus is in the idle state, the first functional component may be rebooted again to ensure that the interaction between the first functional component and the shared bus is completed, so that the shared bus may continue to normally process access requests of other operating systems or functional components, thereby ensureing the normal operation of the shared bus.

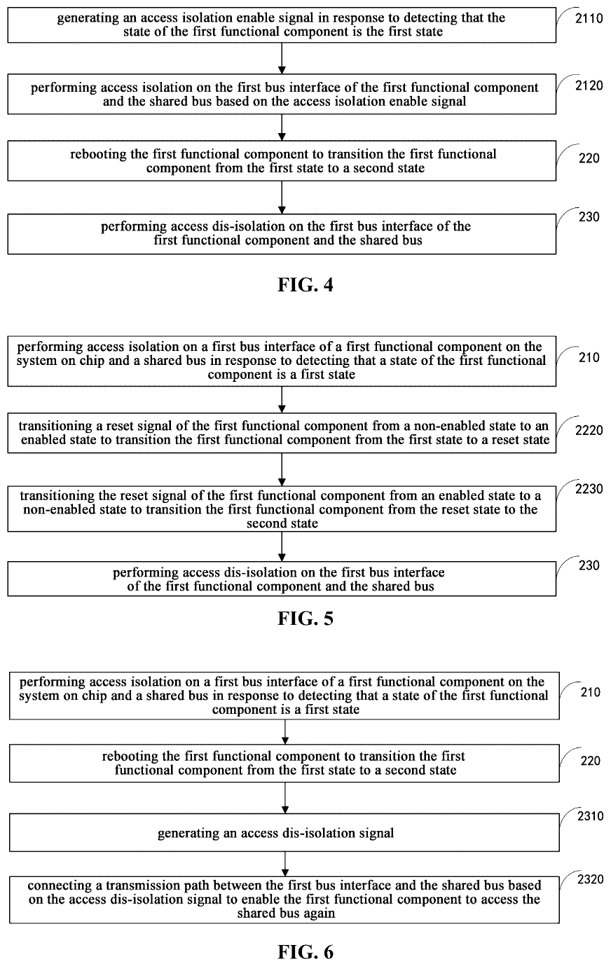

FIG. 4 is a schematic flow diagram showing a method for rebooting a functional component on a system on chip according to yet another example embodiment of the present disclosure.

In some alternative embodiments, on the basis of any one of the above-mentioned embodiments, as shown in FIG. 4, the step 210 of performing access isolation on a first bus interface of a first functional component on the system on chip and a shared bus in response to detecting that a state of the first functional component is a first state may include:

step 2110: generating an access isolation enable signal in response to detecting that the state of the first functional component is the first state.

The access isolation enable signal may be a 1 or a high-level signal, or the access isolation enable signal may be a 0 or a low level signal, which may be specifically set as needed.

In some alternative embodiments, the access isolation enable signal may be generated by a register, i.e., the access isolation enable signal is generated by updating the value of the register from a value representing non-enabling to a value representing enabling.

In some alternative embodiments, the access isolation enable signal may be generated by controlling the level of the signal.

Step 2120: performing access isolation on the first bus interface of the first functional component and the shared bus based on the access isolation enable signal.

The execution of the access isolation is triggered by the access isolation enable signal, i.e., access isolation may be performed on the first bus interface of the first functional component and the shared bus in response to the access isolation enable signal.

In some alternative embodiments, step 2120 of performing access isolation on the first bus interface of the first functional component and the shared bus according to the access isolation enable signal may include: disconnecting, based on the access isolation enable signal, a transmission path between the first bus interface and the shared bus to prevent an access request of the first functional component from being transmitted to the shared bus. For example, the access isolation enable signal is provided to the controller of a bus switch provided on a transmission path between the first bus interface and the shared bus, and the controller controls the bus switch to be switched off in response to the access isolation enable signal, thereby disconnecting the transmission path between the first bus interface and the shared bus.

In some alternative embodiments, the step 2120 of performing access isolation on the first bus interface of the first functional component and the shared bus based on the access isolation enable signal may include: terminating, based on the access isolation enable signal, forwarding the access request of the first functional component to the shared bus. For example, in a case where the access request and the response information are forwarded by the forwarding controller, which is connected to the first bus interface and the shared bus, respectively, and an access isolation enable signal is provided to the forwarding controller, and the forwarding controller terminates forwarding the access request of the first functional component to the shared bus in response to the access isolation enable signal.

According to the present embodiment of the present disclosure, accurate control over the access isolation action of the hardware for access isolation is achieved by generating an access isolation enable signal to trigger access isolation in a case where anomalies in the first functional component are detected.

FIG. 5 is a schematic flow diagram showing a method for rebooting a functional component on a system on chip according to yet still another example embodiment of the present disclosure.

In some alternative embodiments, on the basis of any one of the embodiments described above, as shown in FIG. 5, the step 220 of rebooting the first functional component to transition the first functional component from the first state to a second state may include:

step 2220: transitioning a reset signal of the first functional component from a non-enabled state to an enabled state to transition the first functional component from the first state to a reset state.

The enabled state of the reset signal may be 0 or a low-level state, and the corresponding non-enabled state of the reset signal is 1 or a high-level state. In practice, the enabled state of the reset signal may also be a 1 or high-level state, and the non-enabled state of the reset signal may be a 0 or low-level state. It is not specifically limited.

In some alternative embodiments, the first functional component may include a reset pin through which a reset signal is provided to the first functional component. For example, the first functional component is reset from the first state to the reset state in response to the reset enable signal by bring the level of the reset pin from a high level to a low level, indicating a transition of the reset signal from the non-enabled state to the enabled state. The specific operation of the first functional component to reset in response to the reset enable signal is a conventional operation and will not be described in detail herein.

Step 2230: transitioning the reset signal of the first functional component from an enabled state to a non-enabled state to transition the first functional component from the reset state to the second state.

The first functional component cannot operate normally in the reset state, and needs to perform de-reset, i.e., the reset signal of the first functional component is transitioned from the enabled state to the non-enabled state, such that the first functional component is de-reset, and is transitioned from the reset state to the second state, i.e., from the reset state to a normal state. In this case, although the first functional component may operate normally, in a case where no task is allocated, the first functional component is in an idle state, and after the task is allocated, the first functional component enters an operating state from an idle state.

In some alternative embodiments, the first functional component may be de-reset by bringing the reset pin of the first functional component from a low level to a high level, indicating that the reset signal transitions from an enabled state to a non-enabled state. The specific operation of the first functional component to de-reset is a conventional operation and will not be described in detail herein.

In the present embodiment, by controlling the enabling and non-enabling of the reset signal of the first functional component to realize the reset and de-reset of the first functional component, thereby restoring the first functional component from an abnormal state to a normal state and realizing the independent rebooting of the first functional component, it is possible to prevent affecting the normal operation of other functional components and ensure the overall stability of the system.

In some alternative embodiments, the step 2210 of rebooting the first functional component in response to detecting that the first bus interface and the shared bus are in the idle state to transition the first functional component from the first state to a second state may include: transitioning a reset signal of the first functional component from a non-enabled state to an enabled state to transition the first functional component from the first state to a reset state; and transitioning the reset signal of the first functional component from an enabled state to a non-enabled state to transition the first functional component from the reset state to the second state. The specific operation of the first functional component from the first state to the second state is described with reference to the previous embodiments and will not be described in detail here.

In some alternative embodiments, the de-resetting of step 2230 and the access dis-isolation of step 230 may be out of order. That is, after step 2220 of transitioning a reset signal of the first functional component from a non-enabled state to an enabled state to transition the first functional component from the first state to a reset state, step 230 may be executed for access dis-isolation. For example, it is possible that de-reset is performed, and then the access dis-isolation is performed; or the access dis-isolation is performed, and then the de-reset is performed; or the de-reset and the access dis-isolation are performed in parallel. It is not specifically limited.

FIG. 6 is a schematic flow diagram showing a method for rebooting a functional component on a system on chip according to yet another example embodiment of the present disclosure.

In some alternative embodiments, on the basis of any one of the of the above-mentioned embodiments, as shown in FIG. 6, the step 230 of performing access dis-isolation on the first bus interface of the first functional component and a shared bus may include:

step 2310: generating an access dis-isolation signal.

The access dis-isolation signal may be a non-enable signal corresponding to the above-mentioned access isolation enable signal. For example, if the access isolation enable signal is a 1 or high-level signal, the access dis-isolation signal is a 0 or low-level signal. If the access isolation enable signal is a 0 or low-level signal, the access dis-isolation signal is a 1 or high-level signal. The access dis-isolation signal is generated in a manner similar to that for the access isolation enable signal, e.g., by updating a value of a register or controlling the level to indicate the generated access dis-isolation signal, which will not be described in detail.

Step 2320: connecting a transmission path between the first bus interface and the shared bus based on the access dis-isolation signal to enable the first functional component to access the shared bus again.

In a case where access isolation is achieved by disconnecting a transmission path between the first bus interface and the shared bus, the transmission path between the first bus interface and the shared bus is connected according to an access dis-isolation signal to dis-isolate the access. The operation of connecting the transmission path between the first bus interface and the shared bus is a reverse operation of disconnecting the transmission path. For example, by controlling the bus switch to be switched on, a transmission path between the first bus interface and the shared bus is communicated so that the first functional component may again access the shared bus.

In the present embodiment, after the first functional component returns to normal, by connecting the transmission path between the first bus interface and the shared bus to achieve the access dis-isolation, the normal access by the first functional component to the shared bus may be ensured to be restored, so that the first functional component may be reused for executing corresponding functional tasks.

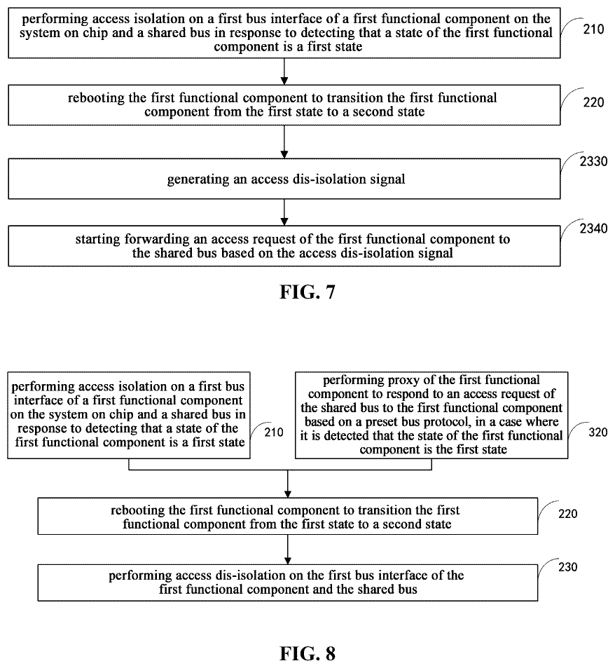

FIG. 7 is a schematic flow diagram showing a method for rebooting a functional component on a system on chip according to yet still another example embodiment of the present disclosure.

In some alternative embodiments, on the basis of any one of the of the above-mentioned embodiments, as shown in FIG. 7, the step 230 of performing access dis-isolation on the first bus interface of the first functional component and the shared bus may include:

step 2330: generating an access dis-isolation signal.

The access dis-isolation signal may be referred to the aforementioned embodiments.

Step 2340: starting forwarding an access request of the first functional component to the shared bus based on the access dis-isolation signal.

In a case of performing access isolation by terminating forwarding an access request, according to an access dis-isolation signal, a forwarding function of the access request is restarted to forward the access request initiated by the first functional component to the shared bus, ensuring the normal access of the first functional component to the shared bus, and enabling the first functional component to be re-invoked to execute a corresponding functional task.

FIG. 8 is a schematic flow diagram showing a method for rebooting a functional component on a system on chip according to yet another example embodiment of the present disclosure.

In some alternative embodiments, on the basis of any one of the embodiments described above, as shown in FIG. 8, the method in the embodiment of the present disclosure may further include:

step 320: performing proxy of the first functional component to respond to an access request of the shared bus to the first functional component based on a preset bus protocol, in a case where it is detected that the state of the first functional component is the first state.

The proxy of the first functional component may refer to taking over the operation of responding to the access request of the shared bus, i.e., since the state of the first functional component is an abnormal state, the access request of the shared bus cannot be responded to normally, the first functional component is replaced to respond to the access request of the shared bus so as to prevent hanging when the shared bus is not responded for a long time. Bus hanging is the failure of a device on the bus to communicate properly for some reason. For example, in a case where the first functional component is abnormal, the shared bus will fail to receive a respond for a long time, and the shared bus waits for the first functional component to reply, resulting in the failure of other functional components or operating systems on the shared bus to initiate communications normally, a phenomenon of which may be referred to bus hanging. In an embodiment of the present disclosure, in order to prevent the shared bus from hanging, in a case where it is detected that a state of the first functional component is a first state, proxy of the first functional component is performed to respond to an access request of the shared bus to the first functional component according to a preset bus protocol.

In some alternative embodiments, the access request by the shared bus to the first functional component may be an access request by another functional component or operating system to access the first functional component via the shared bus. The access request may include commands and/or data. For example, the access request includes a command for the operating system to assign a task to the first functional component and/or task-related data, etc. The tasks may be, for example, signal processing tasks, graphics processing tasks, etc. The command may be a command corresponding to a signal processing task and a command corresponding to a graphics processing task. The task-related data may be signal data to be processed corresponding to a signal processing task and graphic data to be processed corresponding to a graphics processing task.

In some alternative embodiments, the predetermined bus protocol may be a bus protocol employed by the first functional component to communicate with the shared bus. An access request of a shared bus to a first functional component is responded to according to a preset bus protocol to ensure that response information about the shared bus complies with a corresponding bus protocol; however, since the first functional component is abnormal, data which should be returned by the first functional component cannot be obtained, and specific data in the response information responded by the proxy may not be valid data. For example, the first functional component is an ISP, an access request of the shared bus is a signal processing task allocated to the first functional component, and in a case where the first functional component is abnormal, the signal processing task cannot be completed, and therefore task execution result data cannot be obtained; and response information responding to the access request by the proxy of first functional component complies with an information format of a preset bus protocol, but specific result data is invalid result data. In general, a demander of result data (such as a perception application in an operating system) has a detection function for the result data, and invalid data may be unused when it is detected, or other relevant measures may be taken, so that other operating systems and functional components are not adversely affected.

In some alternative embodiments, proxy of the first functional component is performed to respond to an access request of the shared bus to the first functional component based on a preset bus protocol by a hanging preventing functional module which may be provided between the second bus interface of the first functional component and the shared bus. The second bus interface, which may be referred to as a Slave bus interface, is an interface for receiving access requests actively initiated by the shared bus and returning response information to the shared bus. The hanging preventing functional module may be implemented using any circuit structure capable of implementing the hanging preventing function, and the embodiments of the present disclosure are not limited thereto.

It should be noted that step 320 and step 210 are out of order. That is, the order of entering the access isolation state and entering the proxy state is not limited, and the access isolation state may be entered first, or the proxy state may be entered first, or the access isolation state and the proxy state may be entered simultaneously.

In the present embodiment, in a case where it is detected that a state of the first functional component is the first state, proxy of the first functional component is performed to respond to an access request of the shared bus to the first functional component based on a preset bus protocol, which may effectively prevent the shared bus from hanging and ensure the normal operation of other functional components and operating systems.

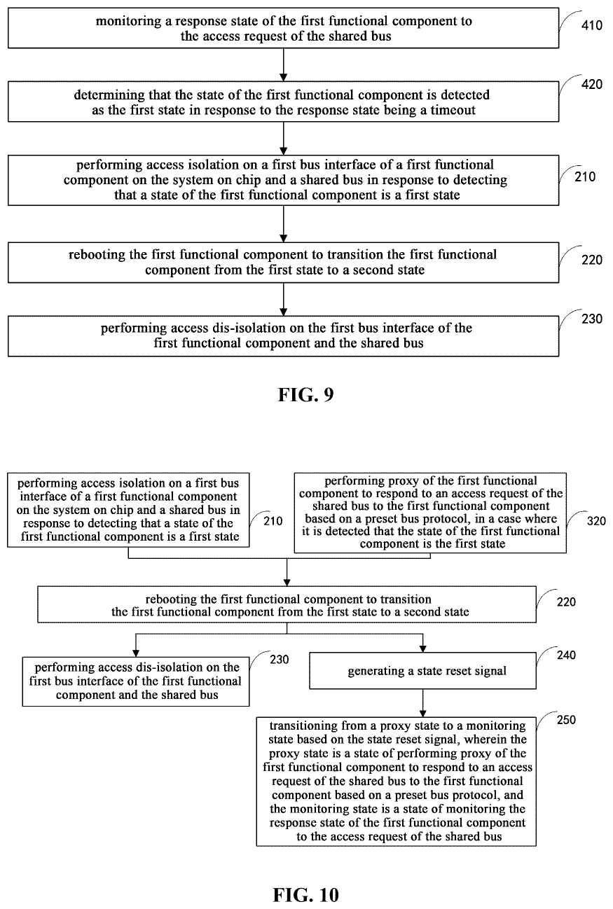

FIG. 9 is a schematic flow diagram showing a method for rebooting a functional component on a system on chip according to yet still another example embodiment of the present disclosure.

In some alternative embodiments, on the basis of any one of the above embodiments, as shown in FIG. 9, in a case where the state of the first functional component is the second state, the method in the embodiment of the present disclosure may further include:

step 410: monitoring a response state of the first functional component to the access request of the shared bus.

A response state of the first functional component to the access request of the shared bus refers to a state where the first functional component does not respond to whether the access request times out. A response state of the first functional component to the access request of the shared bus may include both timeout and non-timeout states.

In some alternative embodiments, a response state of the first functional component to the access request of the shared bus may be monitored by a hanging preventing functional module between the second bus interface of the first functional component and the shared bus. For example, after receiving the access request of the shared bus, the hanging preventing functional module may apply for a cache to record the access request, and may start one timer as a timer corresponding to the access request, and forward the access request to the second bus interface for transmission to the first functional component. If the hanging preventing functional module receives the response information about the access request by the first functional component within a specified time duration, timing by a timer corresponding to the access request is stopped, and the response information is forwarded to the shared bus, and the cache taken up by the access request is released. If the timer corresponding to the access request exceeds the specified time, the hanging preventing functional module still does not receive the response information of the first functional component corresponding to the access request, or if the timer corresponding to the access request exceeds the specified time, the cache taken up by the access request is still not released, and it is determined that a response state of the first functional component to the access request of the shared bus is a timeout.

Step 420: determining that the state of the first functional component is detected as the first state in response to the response state being a timeout.

If a response state of the first functional component to the access request of the shared bus is a timeout, indicating that the first functional component may be abnormal, it is determined that the state of the first functional component detected is a first state (i.e., an abnormal state). Thus, access isolation may in turn be performed on the first bus interface of the first functional component and the shared bus.

In some alternative embodiments, in response to the response state of the first functional component to the access request of the shared bus being a timeout, proxy of the first functional component may be performed to respond to an access request by the shared bus to the first functional component based on a preset bus protocol.

In some alternative embodiments, in a case where the hanging preventing functional module detects that the state of the first functional component is an abnormal state, the hanging preventing functional module may feed back abnormal state information to an associated software module, and the software module may perform access isolation on the first bus interface of the first functional component and the shared bus in response to detecting that the state of the first functional component is an abnormal state.

In the present embodiment, by monitoring a response state of the first functional component to the access request of the shared bus, an abnormal state of the first functional component may be detected in time, and the first functional component is rebooted in time according to the method according to the embodiment of the present disclosure, so that the first functional component may recover to a normal state as soon as possible to ensure the stability of an overall system of a system on chip.

In some alternative embodiments, the hanging preventing functional module may autonomously enter a proxy state, perform proxy of the first functional component to respond to an access request of the shared bus to the first functional component based on a preset bus protocol, in a case where a response state of the first functional component to the access request of the shared bus is monitored as a timeout.

In some alternative embodiments, a proxy enable signal may be generated in a case where it is detected that a state of the first functional component is a first state; and thus in response to the proxy enable signal, proxy of the first functional component is performed to respond to an access request by the shared bus to the first functional component based on a preset bus protocol. The proxy enable signal may be a 0 or low-level signal, or alternatively, the proxy enable signal may be a 1 or high-level signal. The proxy enable signal is used to indicate that a proxy state is entered, i.e., proxy of the first functional component is performed to respond to an access request of the shared bus to the first functional component based on a preset bus protocol.

In some alternative embodiments, the generated proxy enable signal may be transmitted to the hanging preventing functional module, and the hanging preventing functional module enters a proxy state in response to the proxy enable signal, proxy of the first functional component is performed to respond to an access request of the shared bus to the first functional component based on a preset bus protocol.

FIG. 10 is a schematic flow diagram showing a method for rebooting a functional component on a system on chip according to yet another example embodiment of the present disclosure.

In some alternative embodiments, on the basis of any one of the embodiments described above, as shown in FIG. 10, after rebooting the first functional component, the method according to the embodiment of the present disclosure may further include:

step 240: generating a state reset signal.

The state reset signal (which may also be referred to as a proxy non-enable signal or a proxy exit enable signal) is a signal for indicating terminating the proxy of the first functional component to respond to an access request of the shared bus to the first functional component based on a preset bus protocol, and starting monitoring a response state of the first functional component to the access request of the shared bus.

Step 250: transitioning from a proxy state to a monitoring state based on the state reset signal, wherein the proxy state is a state of performing proxy of the first functional component to respond to an access request of the shared bus to the first functional component based on a preset bus protocol, and the monitoring state is a state of monitoring the response state of the first functional component to the access request of the shared bus.

The transition from the proxy state to the monitoring state refers to terminating the proxy of the first functional component to respond to an access request of the shared bus to the first functional component based on a preset bus protocol, and starting monitoring a response state of the first functional component to the access request of the shared bus. Since the first functional component has transitioned to the normal state after rebooting the first functional component, the access request of the shared bus may be normally responded to, and therefore, the operation of performing proxy of the first functional component in response to the access request may be terminated. Thus, a transition is made to the above-mentioned step 410 of monitoring a response state of the first functional component to the access request of the shared bus, so that in a case where the first functional component is abnormal again, the abnormal state of the first functional component may be detected in time, and the hanging preventing function is performed. It is not described in detail.

It should be noted that steps 240 through 250 are performed out of order with step 230.

In the present embodiment, after the first functional component is restored to a normal state, by generating a state reset signal to trigger to terminate proxy of the first functional component to respond to the access request and instead continuing to monitor a response state of the first functional component to the access request of the shared bus, it may be ensured that the first functional component being abnormal each time may be detected in time and the component may be restored independently, preventing affecting a normal operation of other functional components and operating systems on the shared bus.

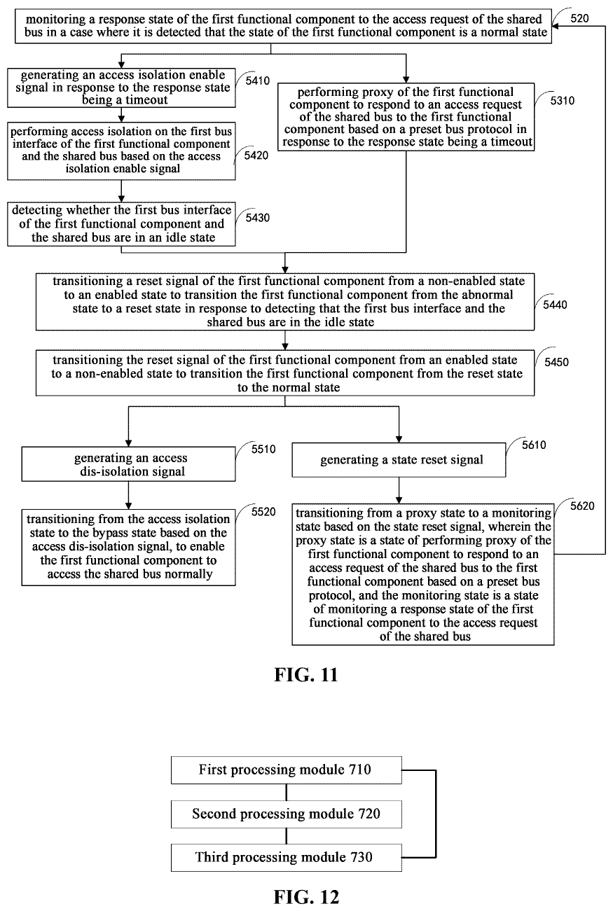

In some alternative embodiments, FIG. 11 is an overall schematic flow diagram showing a method for rebooting a functional component on a system on chip according to an example embodiment of the present disclosure. As shown in FIG. 11, the method may include the following steps:

step 520: monitoring a response state of the first functional component to the access request of the shared bus in a case where it is detected that the state of the first functional component is a normal state (i.e., a second state). Proceeding to step 5310 and step 5410.

step 5310: performing proxy of the first functional component to respond to an access request of the shared bus to the first functional component based on a preset bus protocol in response to the response state being a timeout.

In some alternative embodiments, in response to the proxy enable signal, proxy of the first functional component is performed to respond to an access request of the shared bus to the first functional component based on a preset bus protocol.

Step 5410: generating an access isolation enable signal in response to the response state being a timeout. That is, if the response state is a timeout, it may be indicated that a state of the first functional component is a first state (i.e., an abnormal state), and an access isolation enable signal is generated.

Step 5420: performing access isolation on the first bus interface of the first functional component and the shared bus based on the access isolation enable signal.

Step 5430: detecting whether the first bus interface of the first functional component and the shared bus are in an idle state.

Step 5440: transitioning a reset signal of the first functional component from a non-enabled state to an enabled state to transition the first functional component from the abnormal state to a reset state in response to detecting that the first bus interface and the shared bus are in the idle state.

Step 5450: transitioning the reset signal of the first functional component from an enabled state to a non-enabled state to transition the first functional component from the reset state to the normal state. Proceeding to step 5510 and step 5610.

Step 5510: generating an access dis-isolation signal.

Step 5520: performing access dis-isolation based on the access dis-isolation signal, to enable the first functional component to access the shared bus normally.

Step 5610: generating a state reset signal.

Step 5620: transitioning from a proxy state to a monitoring state based on the state reset signal, wherein the proxy state is a state of performing proxy of the first functional component to respond to an access request of the shared bus to the first functional component based on a preset bus protocol, and the monitoring state is a state of monitoring a response state of the first functional component to the access request of the shared bus. Returning to step 510.

The specific operations of the above steps 510 to 5620 may be referred to in the foregoing embodiments, and will not be described in detail herein.

The method according to the embodiment of the present disclosure may detect an abnormal state of a first functional component in time by monitoring a response state of the first functional component to an access request of a shared bus. In addition, in a case where an abnormal state of the first functional component is detected, access isolation may be performed on the first functional component and the shared bus, and the abnormal first functional component is prevented to initiate an unexpected access operation to the shared bus, so that influence on the normal operation of other functional components and operating systems on the shared bus may be effectively prevented. Secondly, in a case where the first functional component responds is determined as a timeout or the first functional component is abnormal, proxy of the first functional component may also be performed to respond to the access request of the shared bus to the first functional component, effectively preventing the shared bus from hanging due to the lack of reply for a long time. Again, after the first functional component returns to normal, the access dis-isolation may be performed in time to restore normal access of the first functional component to the shared bus. In addition, proxy of the first functional component may be terminated to respond to the access request, instead a response state of the first functional component to the access request is monitored to detect a second anomaly of the first functional component in time. The following automated flow for functional components is implemented: monitoring, isolation and proxy response, rebooting, dis-isolation (transition from proxy response to monitoring), monitoring, isolation and proxy response, rebooting, dis-isolation (transition from proxy response to monitoring), monitoring, . . . , independent reset of functional components is achieved without affecting the normal operation of other functional components and operating system on the shared bus.

The above-mentioned embodiments of the present disclosure may be implemented alone or in any combination without conflict, and specifically may be set as needed, and the present disclosure is not limited thereto.

Any method for rebooting a functional component on a system on chip provided according to an embodiment of the present disclosure may be performed by any suitable electronic device having data processing capabilities, including but not limited to: an electronic device such as a terminal device and a server. Alternatively, any method for rebooting a functional component on a system on chip provided in an embodiment of the present disclosure may be executed by a processor, such as a processor executing any method for rebooting a functional component on a system on chip mentioned by an embodiment of the present disclosure by calling a corresponding instruction stored in a memory. It is not described hereafter in detail.

### Example Apparatus

FIG. 12 is a schematic structural diagram showing an apparatus for rebooting a functional component on a system on chip according to an example embodiment of the present disclosure. The apparatus according to the present embodiment may be used to implement a corresponding method according to the embodiment of the present disclosure and may be provided on a system on chip. The apparatus as shown in FIG. 12 may include: a first processing module 710, a second processing module 720 and a third processing module 730.

The first processing module 710 is configured to perform access isolation on a first bus interface of the first functional component on the system on chip and a shared bus shared by at least two operating systems on the system on chip in response to detecting that a state of the first functional component is a first state.

In some alternative embodiments, the first processing module 710 may be connected to a first bus interface and a shared bus, respectively. The first processing module 710 may include a hardware unit for access isolation. The hardware unit may, for example be a circuit component of a bus switch and its controller, a forwarding controller, etc. as described above, which is capable of performing access isolation on the first bus interface of the first functional component and the shared bus.

In some alternative embodiments, the first processing module 710 may also include a functional unit of software, which may be a processing unit in the processor that performs a corresponding function for controlling an action of the hardware unit.

The second processing module 720 is configured to reboot the first functional component to transition the first functional component from the first state to a second state.

In some alternative embodiments, the second processing module 720 may be connected to the first processing module 710 and the first functional component, respectively. The second processing module 720 may be a functional module in the processor, which is capable of controlling rebooting the first functional component.

The third processing module 730 is configured to perform access dis-isolation on the first bus interface of the first functional component and the shared bus.

In some alternative embodiments, the third processing module 730 may be connected to the second processing module 720 and the first processing module 710, respectively. The third processing module 730 may be a functional module in the processor, which is capable of controlling access dis-isolation of a hardware unit subjected to access isolation.

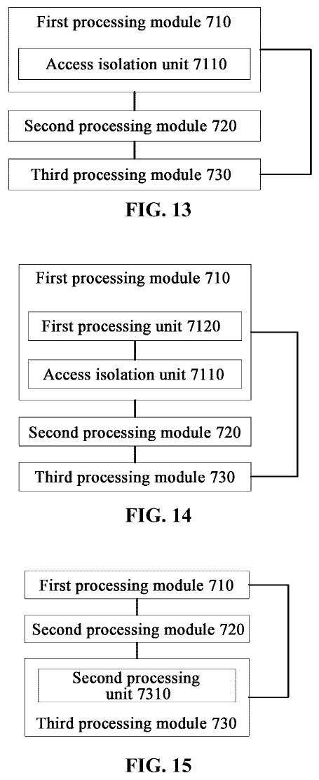

FIG. 13 is a schematic structural diagram showing an apparatus for rebooting a functional component on a system on chip according to another example embodiment of the present disclosure.

In some alternative embodiments, on the basis of the embodiments described in FIG. 12, the first processing module 710 may include: an access isolation unit 7110.

In some alternative embodiments, the access isolation unit 7110 may be adapted to disconnect a transmission path between the first bus interface and the shared bus to prevent an access request by the first functional component from being transmitted to the shared bus.

In some alternative embodiments, the access isolation unit 7110 may be used to terminate forwarding the access request of the first functional component to the shared bus.

In some alternative embodiments, the access isolation unit 7110 may be connected to the first functional component and the shared bus, respectively.

In some alternative embodiments, the access isolation unit 7110 may be a hardware unit capable of disconnecting a transmission path between the first bus interface and the shared bus or terminating forwarding an access request of the first functional component to the shared bus. For example, the access isolation unit 7110 may include a bus switch and its controller as described above, or the access isolation unit 7110 may include a forwarding controller as described above.

In some alternative embodiments, as shown in FIG. 13, the first processing module 710 may include: an access isolation unit 7110.

The access isolation unit 7110 may be used for detecting whether the first bus interface of the first functional component and the shared bus are in an idle state; and sending an idle state signal to the second processing module 720 in response to detecting that the first bus interface and the shared bus are in the idle state.

In some alternative embodiments, the access isolation unit 7110 may also be connected directly or indirectly to the second processing module 720. For example, the access isolation unit 7110 is connected to the processor through an external pin of the processor where the second processing module 720 is located, and thus achieving connection with the second processing module 720. The access isolation unit 7110 may send an idle state signal to the processor, and the processor may transmit in turn the idle state signal to the second processing module 720 in the processor. Alternatively, the access isolation unit 7110 writes a state reset signal to a register and the processor retrieves the state reset signal from the register for transmission to the second processing module 720.

Specifically, the second processing module 720 is configured to reboot the first functional component in response to the idle state signal.

In some alternative embodiments, the second processing module 720, after receiving the idle state signal, reboots the first functional component to transition the first functional component from the first state to the second state.

FIG. 14 is a schematic structural diagram showing an apparatus for rebooting a functional component on a system on chip according to yet another example embodiment of the present disclosure.

In some alternative embodiments, the first processing module 710 may include: an access isolation unit 7110 and a first processing unit 7120.

The first processing unit 7120 may be configured to generate an access isolation enable signal in response to detecting that the state of the first functional component on the system on chip is a first state.

In some alternative embodiments, the first processing unit 7120 may be a processing unit in a processor that performs a corresponding function.

The access isolation unit 7110 may be configured to perform access isolation on the first bus interface of the first functional component and the shared bus in response to an access isolation enable signal. The access isolation unit 7110 may be connected directly or indirectly to the first processing unit 7120, for example, via a register to receive an access isolation enable signal via the register.

In some alternative embodiments, the access isolation unit 7110 may be a circuit component connected to the first bus interface and the shared bus, respectively.

In some alternative embodiments, the access isolation unit 7110 may be specifically used for disconnecting a transmission path between the first bus interface and the shared bus to prevent an access request of the first functional component from being transmitted to the shared bus in response to the access isolation enable signal.

In some alternative embodiments, the access isolation unit 7110 may be specifically used for terminating forwarding the access request of the first functional component to the shared bus in response to the access isolation enable signal.

In some alternative embodiments, the access isolation unit 7110 may also be used for detecting whether the first bus interface of the first functional component and the shared bus are in an idle state; and sending an idle state signal to the second processing module in response to detecting that the first bus interface and the shared bus are in the idle state. The second processing module 720 is specifically configured to reboot the first functional component in response to the idle state signal.

In some alternative embodiments, the second processing module 720 may be specifically configured to transition a reset signal of the first functional component from a non-enabled state to an enabled state to transition the first functional component from the first state to a reset state; and transition the reset signal of the first functional component from an enabled state to a non-enabled state to transition the first functional component from the reset state to the second state.

In some alternative embodiments, on the basis of rebooting the first functional component, the ranges of resetting and de-resetting may further include an access isolation unit 7110, i.e., the access isolation unit 7110 may be reset and de-reset at the same time as resetting and de-resetting the first functional component to ensure the normal operation of the access isolation unit 7110 and prevent the access isolation unit 7110 from being abnormal under the influence of the abnormal first functional component. In this case, the reset signal of the first functional component may be simultaneously provided to the access isolation unit 7110 to trigger the reset and the de-reset of the access isolation unit 7110, or the reset signal of the first functional component may simultaneously trigger the reset and the de-reset of the first functional component and the access isolation unit 7110 according to the connection relationship between the first functional component and the access isolation unit, and the specific manner of triggering the access isolation unit 7110 is not limited.

In some alternative embodiments, in a case where the access isolation unit 7110 is not susceptible to an abnormal first functional component, the ranges of resetting and de-resetting may cover only the first functional component. In a case where the anomaly occurs in the access isolation unit 7110 which may be affected by the abnormal first functional component, the ranges of resetting and de-resetting may cover the first functional component and the access isolation unit 7110. The specific ranges of resetting and de-resetting may be set according to the degree of independence of the access isolation unit 7110 from the first functional component. For example, if the functional logic of the access isolation unit 7110 is more complex or powerful such that the access isolation unit 7110 is not susceptible to anomalies from the first functional component, the ranges of resetting and de-resetting may cover only the first functional component without encompassing the access isolation unit 7110. Otherwise, the ranges of resetting and de-resetting may cover the first functional component and the access isolation unit 7110.

FIG. 15 is a schematic structural diagram showing an apparatus for rebooting a functional component on a system on chip according to yet still another example embodiment of the present disclosure.

In some alternative embodiments, as shown in FIG. 15, the third processing module 730 may include: a second processing unit 7310.

The second processing unit 7310 may be configured to generate an access dis-isolation signal and transmit the access dis-isolation signal to the first processing module 710.

The second processing unit 7310 is connected to the second processing module 720 and the first processing module 710, respectively.

In some alternative embodiments, the second processing unit 7310 may be connected to the access isolation unit 7110 in the first processing module 710 to transmit an access dis-isolation signal to the access isolation unit 7110 to trigger the access isolation unit 7110 to perform an access dis-isolation action to restore normal access of the first functional component to the shared bus.

In some alternative embodiments, the second processing unit 7310 may be a processing unit in a processor. For example, the second processing unit 7310 writes an access dis-isolation signal to a register through which the access dis-isolation signal is provided to the first processing module 710. Alternatively, the second processing unit 7310 updates the level of the access isolation enable terminal of the first processing module 710 to a level indicating non-enabling, and the level indicating non-enabling is opposite to the above-mentioned access isolation enable signal, for example, when the access isolation enable signal is high level, the level indicating non-enabling is low.

The first processing module 710 may also be configured to connect a transmission path between the first bus interface and the shared bus based on the access dis-isolation signal to enable the first functional component to access the shared bus again. Alternatively, the first processing module may further be configured to start forwarding an access request of the first functional component to the shared bus in response to the access dis-isolation signal.

In some alternative embodiments, the access isolation unit 7110 in the first processing module 710 may also be used for connecting a transmission path between the first bus interface and the shared bus based on the access dis-isolation signal to enable the first functional component to access the shared bus. Alternatively, an access request of the first functional component to the shared bus is started to be forwarded in response to the access dis-isolation signal.

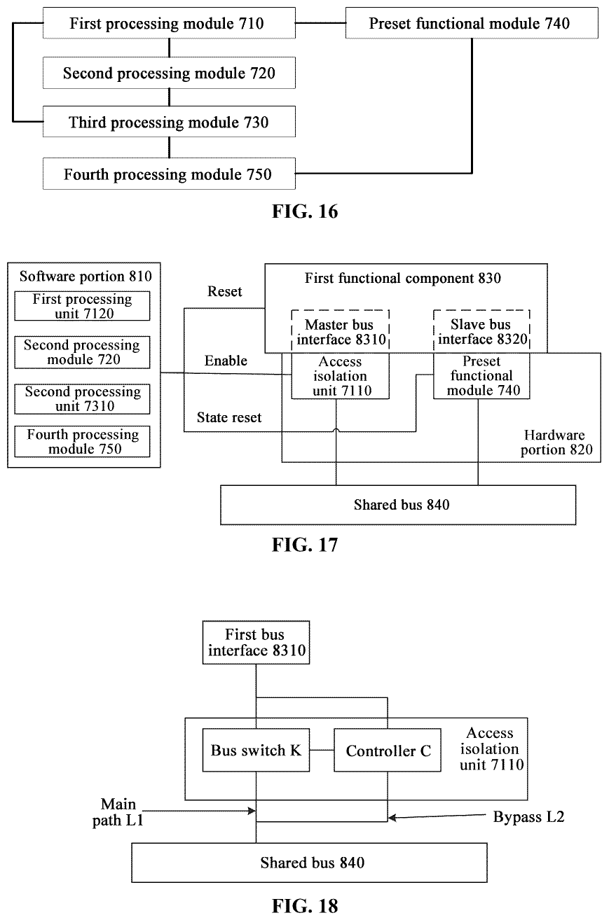

FIG. 16 is a schematic structural diagram showing an apparatus for rebooting a functional component on a system on chip according to yet another example embodiment of the present disclosure.

In some alternative embodiments, on the basis of any one of the embodiments described above, as shown in FIG. 16, the apparatus according to an embodiment of the present disclosure may further include: a preset functional module 740. The preset functional module 740 is also the above-mentioned hanging preventing functional module.

In some alternative embodiments, the preset functional module 740 is connected to the second bus interface of the first functional module and the shared bus, respectively. The second bus interface of the first functional component, which may be referred to as a Slave bus interface, is an interface for receiving access requests actively initiated by the shared bus and returning response information to the shared bus.

In some alternative embodiments, the preset functional module 740 may be configured to, in a case where it is detected that the state of the first functional component is the first state, perform proxy of the first functional component to respond to an access request of the shared bus to the first functional component based on a preset bus protocol.

In some alternative embodiments, the preset functional module 740 may be implemented using any implementable circuit components. For example, the preset functional module 740 may use a controller or a microprocessor, etc. to implement a corresponding proxy response function, i.e., proxy of the first functional component is performed to respond to an access request of the shared bus to the first functional component based on a preset bus protocol.

In some alternative embodiments, in a case where the state of the first functional component is a second state, the preset functional module 740 may also be configured to monitor a response state of the first functional component to an access request of the shared bus; and determine that the state of the first functional component is detected as the first state in response to the response state being a timeout.

In some alternative embodiments, the preset functional module 740 may monitor the response state of the first functional component via a timer, controller (or microprocessor), buffer, etc. For example, after receiving an access request of the shared bus, the controller of the preset functional module 740 records the access request via a buffer, and may start a timer as a timer corresponding to the access request, and forwards the access request to the second bus interface for transmission to the first functional component. If the response information of the first functional component to the access request is received within a specified time duration, the controller of the preset functional module 740 stops timing by a timer corresponding to the access request, and forwards the response information to the shared bus, and releases the cache taken up by the access request. If the timer corresponding to the access request exceeds a specified time, the controller of the preset functional module 740 still does not receive the response information corresponding to the access request of the first functional component, or if the timer corresponding to the access request exceeds a specified time, the cache taken up by the access request is still not released, and it is determined that a response state of the first functional component to the access request of the shared bus is a timeout.

In some alternative embodiments, the preset functional module 740 may autonomously enter a proxy state, i.e., perform proxy of the first functional component to respond to any access request of the shared bus to the first functional component based on a preset bus protocol, in a case where a response state of the first functional component to the access request of the shared bus is monitored as a timeout.

In some alternative embodiments, the preset functional module 740 may passively enter a proxy state in response to the proxy enable signal, i.e., perform proxy of the first functional component to respond to an access request of the shared bus to the first functional component based on a preset bus protocol. The proxy enable signal may be generated by a module or unit in the processor and transmitted to a preset functional module 740 which performs proxy of the first functional component to respond to an access request of the shared bus to the first functional component based on a preset bus protocol.

In some alternative embodiments, as shown in FIG. 16, the apparatus of the embodiment of the present disclosure may further include: a fourth processing module 750.

The fourth processing module 750 may be configured to send a state reset signal to the preset functional module 740 after rebooting the first functional component.

In some alternative embodiments, the fourth processing module 750 may be a processing module in a processor that sends a state reset signal to the preset functional module 740 after rebooting the first functional component.

The preset functional module 740 is further configured to transition from a proxy state to a monitoring state based on the state reset signal, wherein the proxy state is a state of performing proxy of the first functional component to respond to an access request of the shared bus to the first functional component based on a preset bus protocol, and the monitoring state is a state of monitoring a response state of the first functional component to the access request of the shared bus. That is, the preset functional module 740 is configured to, in response to the state reset signal, terminate the proxy of the first functional component to respond to an access request of the shared bus to the first functional component based on a preset bus protocol, and start monitoring a response state of the first functional component to the access request of the shared bus.

Before the preset functional module 740 receives the state reset signal (i.e., in a case where the preset functional module 740 is in a proxy state), if the shared bus initiates a new access request to the first functional component, the preset functional module 740 performs proxy of the first functional component to respond until the preset functional module 740 transitions from the proxy state to the monitoring state, and the first functional component responds to the access request of the shared bus.

In some alternative embodiments, FIG. 17 is a schematic structural diagram showing an apparatus for rebooting a functional component on a system on chip according to an example embodiment of the present disclosure. As shown in FIG. 17, an apparatus for rebooting a functional component on a system on chip according to an embodiment of the present disclosure may include a software portion 810 and a hardware portion 820. The software portion 810 may include the first processing unit 7120, the second processing module 720, the second processing unit 7310, and the fourth processing module 750 described above. The hardware portion 820 may include the access isolation unit 7110 and the preset functional module (i.e., hanging preventing functional module) 740 described above. The first functional component 830 may include a Master bus interface 8310 and a Slave bus interface 8320. The Master bus interface 8310 is the first bus interface. The Slave bus interface 8320 is the second bus interface. The access isolation unit 7110 is connected to a Master bus interface 8310 and a shared bus 840, respectively. The preset functional module 740 is connected to the Slave bus interface 8320 and the shared bus 840, respectively. Based on the structure shown in FIG. 17, taking the case where the ranges of resetting and de-resetting cover only the first functional component 830 but does not include the access isolation unit 7110 as an example, the operation processes of the apparatus according to the embodiment of the present disclosure may include the following processes 1, 2 and 3:

Process 1: in a case where the state of the first functional component 830 is a normal state, the access isolation unit 7110 is in a bypass state (or referred to as an dis-isolation state), i.e., the access isolation unit 7110 does not perform access isolation on the Master bus interface 8310 and the shared bus 840, and does not affect the transmission path between the Master bus interface 8310 and the shared bus 840, and the Master bus interface 8310 may normally access the shared bus 840. The first functional component 830 may initiate an access request to the shared bus 840 via the Master bus interface 8310 and receive response information of the shared bus 840 for the access request. In a case where the state of the first functional component 830 is a normal state (a second state), the shared bus 840 may initiate an access request to the first functional component 830 via the Slave bus interface 8320 and receive response information of the first functional component 8320 for the access request. In this case, the preset functional module 740 is in a monitoring state, i.e., monitors a response state of the first functional component 830 to an access request of the shared bus 840. If the preset functional module 740 detects that the response state of the first functional component 830 is a timeout, it is determined that the state of the first functional component 830 is detected as an abnormal state (first state).

Process 2: in a case where the preset functional module 740 determines that the state of the first functional component 830 is detected to be an abnormal state (first state), or in a case where the preset functional module 740 monitors that the response state of the first functional component 830 for any access request of the shared bus 840 is a timeout, the preset functional module 740 may feed back to the software portion 810 a notification message that the first functional component 830 is in an abnormal state. In addition, the preset functional module 740 may automatically transition from the monitoring state to the proxy state, i.e., the preset functional module 740 takes over the bus, performs proxy of the first functional component 830, and responds to the access request of the shared bus to the first functional component 830 based on a preset bus protocol, so that the access request of the shared bus 840 to the first functional component 830 may obtain response information in time, and prevents the shared bus 840 from hanging due to lack of response information for a long time, so that the shared bus may continue to operate normally without affecting the normal operation of other functional components and other operating systems. Alternatively, a proxy enable signal may be generated by the software portion 810 and transmitted to the preset functional module 740. And the preset functional module 740 passively transitions from the monitoring state to the proxy state in response to the proxy enable signal, and performs proxy of the first functional component 830 to respond to access request of the shared bus to the first functional component 830 based on a preset bus protocol. The proxy enable signal may be generated, for example, by a fourth processing module 750, and the proxy enable signal is an inverse of the state reset signal to enable a transition from a proxy state to a monitoring state of the preset functional module 740. Alternatively, the proxy enable signal and the state reset signal may be provided to the preset functional module 740 by controlling a change in the signal of one of the proxy enable terminals of the preset functional module 740, i.e., the proxy enable signal may be provided to the preset functional module 740 by configuring the signal of the proxy enable terminal to be a signal indicating proxy enable (e.g., 1 or high level). The preset functional module 740 may be provided with a state reset signal by configuring a signal on the proxy enable terminal to indicate a proxy non-enable signal (e.g., 0 or low level). After acquiring the notification message of the preset functional module 740, the first processing unit 7120 of the software portion 810 determines that the state of the first functional component 830 is detected as an abnormal state, generates an access isolation enable signal, and transmits the access isolation enable signal to the access isolation unit 7110, where the access isolation enable signal is provided to the access isolation unit 7110 via an enable end of the access isolation unit 7110. In response to the access isolation enable signal, the access isolation unit 7110 transitions from the bypass state to the access isolation state, i.e., access isolation is performed on the Master bus interface 8310 of the first functional component 830 and the shared bus 840. For example, the access isolation unit 7110 disconnects a transmission path between the Master bus interface 8310 and the shared bus 840 to prevent an access request of the first functional component 830 from being transmitted to the shared bus 840; or, the access isolation unit 7110 terminates forwarding the access request of the first functional component 830 to the shared bus 840 for access isolation. Furthermore, the access isolation unit 7110 may also wait for response information about an access request that is transmitted to the shared bus 840 before isolation, i.e., whether the Master bus interface 8310 of the first functional component 830 and the shared bus 840 are in an idle state is detected; in a case where all the access requests initiated by the first functional component 830 obtain response information of the shared bus 840, it is determined that the Master bus interface 8310 and the shared bus 840 are detected to be in an idle state, and the access isolation unit 7110 may send an idle state signal to the second processing module 720. In response to the idle state signal, the second processing module 720 transitions a reset signal from a reset end of the first functional component 830 from a non-enabled state to an enabled state to enable the first functional component 830 to reset and transition from an abnormal state to a reset state; the second processing module 720 then transitions the reset signal of the first functional component 830 from the enabled state to the non-enabled state to enable the first functional component 830 to de-reset, and transition from the reset state to the normal state to realize rebooting of the first functional component 830. In practice, alternatively, a reset signal line to which the software portion 810 in FIG. 17 is connected may connect the first functional component 830 and the access isolation unit 7110 at the same time, so that the ranges of resetting and de-resetting may cover the first functional component 830 and the access isolation unit 7110, i.e., by transitioning the reset signal from the non-enabled state to the enabled state, the first functional component 830 may be transitioned from the abnormal state to the reset state while the access isolation unit 7110 is transitioned to the reset state. Thus, by transitioning the reset signal from the enabled state to the non-enabled state, the first functional component may further be transitioned from the reset state to the second state while the access isolation unit 7110 is transitioned from the reset state to the normal state. Alternatively, de-resetting and access dis-isolation may be out of order. If the de-resetting is performed first, after the de-resetting, the access isolation unit 7110 may continue to perform access isolation on the Master bus interface 8310 and the shared bus 840 in response to the access isolation enable signal, until the access isolation unit 7110 receives an access dis-isolation signal, and resumes normal access to the shared bus 840 by the first functional component 830 in response to the access dis-isolation signal. If the access isolation enable signal has been updated to an access dis-isolation signal after de-resetting, the access isolation unit 7110 may perform access dis-isolation and enter a bypass state in response to the access dis-isolation signal. Alternatively, as shown in FIG. 17, the reset and de-reset of the first functional component 830 and the access isolation unit 7110 may be triggered simultaneously by a reset signal of the first functional component.

Process 3: after the first functional component 830 is rebooted, the second processing unit 7310 may generate an access dis-isolation signal (i.e., an access isolation non-enable signal), e.g., if the access isolation enable signal is a 1 or high-level signal, then the access dis-isolation signal is a 0 or low-level signal; if the access isolation enable signal is a 0 or low-level signal, the access dis-isolation signal is a 1 or high-level signal. The second processing unit 7310 transmits an access dis-isolation signal to the access isolation unit 7110, and the access isolation unit 7110 transitions from an access isolation state to a bypass state in response to the access dis-isolation signal, i.e., the access isolation unit 7110 connects a transmission path between the Master bus interface 8310 and the shared bus 840 to enable the first functional component 830 to access the shared bus. Alternatively, the access isolation unit 7110 starts forwarding the access request of the first functional component 830 to the shared bus 840, so that the first functional component 830 may access the shared bus 840. Furthermore, after the first functional component 830 is rebooted, the fourth processing module 750 may also send a state reset signal (i.e., a proxy non-enable signal or a proxy exit enable signal) to the preset functional module 740. The preset functional module 740 is configured to, in response to the state reset signal, transition from a proxy state to a monitoring state, i.e., terminate proxy of the first functional component 830 to respond to an access request of the shared bus 840, and in turn monitor the response state of the first functional component 830 to the access request of the shared bus 840. Entering the above-mentioned process 1, such a cycle may ensure the independent recovery of functional components, prevent affecting other functional components and operating system, and improve the stability of the whole system on chip. The software component 810 may be provided in at least one operating system or may be provided outside the operating system without limitation. If the software portion 810 is in a certain operating system, in a case where the abnormal operating system results in an abnormal functional component, the abnormal operating system may be rebooted by another operating system or a recovery program outside the operating system, etc. and after the operating system is returned to normal, the method for rebooting the functional component on the system on chip according to the embodiment of the present disclosure is executed. If the software portion 810 is provided in a plurality of operating systems, the method according to the embodiment of the present disclosure may be performed by other operating systems that are normally operated in a case where one abnormal operating system causes an abnormal functional component. If the software portion 810 is located outside of the operating system and is not affected by the operating system, the method according to the embodiment of the present disclosure may be performed directly in a case where anomalies of the functional components are detected. The specific deployment locations of the modules and units of the apparatus according to the embodiments of the present disclosure are not limited.

In some alternative embodiments, FIG. 18 is a schematic structural diagram showing an access isolation unit 7110 according to an example embodiment of the present disclosure. As shown in FIG. 18, the access isolation unit 7110 may include a bus switch K and a controller C, and the controller C may control the bus switch K to be switched off to disconnect a transmission path (i.e., a main path L1) between the first bus interface 8310 and the shared bus 840, so that the access request of the first functional component 830 cannot be transmitted to the shared bus 840 for access isolation. The controller C is connected to the shared bus 840 by a bypass L2, so that the response information of the shared bus 840 may be transmitted to the controller C, and the controller C may or may not forward the response information to the first bus interface 8310. The controller C may determine whether the first bus interface 8310 and the shared bus 840 are in an idle state according to the response information of the shared bus 840, and in a case where it is detected that the first bus interface 8310 and the shared bus 840 are in an idle state, the controller C may send an idle state signal to the second processing module 720 to trigger the rebooting of the first functional component 830. After rebooting the first functional component 830, the controller C may control the bus switch K to be switched on to enable the transmission path L1 between the first bus interface 8310 and the shared bus 840 to connect; the first bus interface 8310 accesses the shared bus 840 via the main path L1; and the access isolation unit 7110 enters a bypass state, and no longer affects interaction of access and reply of the main path.

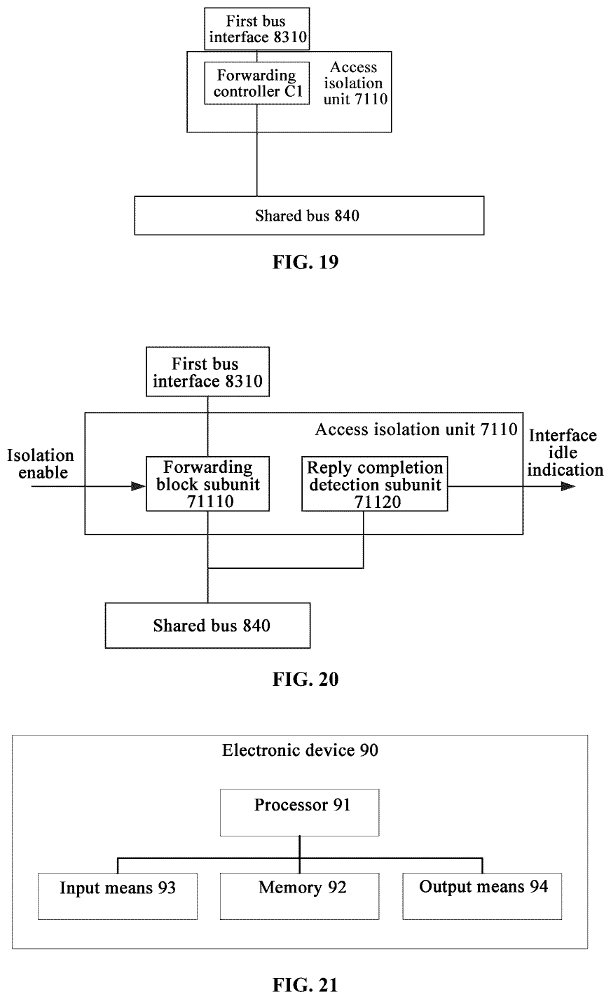

In some alternative embodiments, FIG. 19 is a schematic structural diagram showing an access isolation unit 7110 according to another example embodiment of the present disclosure. As shown in FIG. 19, the access isolation unit 7110 includes a forwarding controller C1, and the access request of the first functional component 830 output through the first bus interface 8310 and the response information of the shared bus 840 are both forwarded by the forwarding controller C1; and in a case where it is necessary to perform access isolation on the first bus interface 8310 and the shared bus 840, the forwarding controller C1 terminates forwarding the access request of the first functional component 830 to the shared bus 840 to achieve access isolation. In a case where access dis-isolation needs to be performed, the forwarding controller C1 resumes the function of forwarding the access request to the shared bus 840 to perform the access dis-isolation.

In some alternative embodiments, FIG. 20 is a schematic structural diagram showing an access isolation unit 7110 according to yet another example embodiment of the present disclosure. As shown in FIG. 20, the access isolation unit 7110 may include a forwarding block subunit 71110 and a reply completion detection subunit 71120. The forwarding block subunit 71110 includes an isolation enable terminal for receiving an access isolation enable signal and an access dis-isolation signal. The reply completion detection subunit 71120 includes an interface idle indication output for outputting an idle state signal. In response to the access isolation enable signal of the isolation enable terminal, the forwarding block subunit 71110 enters an access isolation state, blocks the access request output through the first bus interface 8310, and terminates forwarding the access request to the shared bus 840. The reply completion detection subunit 71120 may detect whether all access requests n sent to the shared bus 840 have all been responded to, i.e., whether all response information of the shared bus 840 has been received. An interface idle indication signal (i.e., an idle state signal) is output if it is detected that all access requests have been replied. The idle state signal may be sent to the second processing module 720 to trigger rebooting of the first functional component 830. After rebooting the first functional component 830, the second processing unit 7310 updates the signal of the isolation enable terminal to an access dis-isolation signal, the forwarding block subunit 71110 transitions from the access isolation state to the bypass state in response to the access dis-isolation signal, continues to forward the access request output through the first bus interface 8310 to the shared bus 840, and resumes the normal access of the first functional component 830 to the shared bus 840.

Advantageous technical effects corresponding to example embodiments of the present device may be seen in the respective advantageous technical effects of the above section described above and will not be described in detail here.

### Example Electronic Device

FIG. 21 is a structural diagram showing an electronic device including at least one processor 91 and memory 92 provided according to an embodiment of the present disclosure.

The processor 91 may be a central processing unit (CPU) or other form of processing unit having data processing capabilities and/or instruction execution capabilities, and may control other components in the electronic device 90 to perform desired functions.

The memory 92 may include one or more computer program products, which may include various forms of computer-readable storage media, such as volatile memory and/or non-volatile memory. The volatile memory may for example include a random-access memory (RAM) and/or a cache memory (cache) etc. The non-volatile memory may include, for example, a read only memory (ROM), a hard disk, a flash memory, etc. One or more computer program instructions may be stored on a computer-readable storage medium, which, when being executed by the processor 91, may cause the processor 91 to perform the methods and/or other desired functions according to the various embodiments of the present disclosure above.

In one example, the electronic device 90 may further include: input means 93 and output means 94, which are interconnected by a bus system and/or other form of connection mechanism (not shown).

The input means 93 may also include, for example, a touch screen, a microphone, various sensors, etc. The sensors may include, for example, image sensors (e.g., cameras, webcams, etc.), lidar, millimeter wave radar, ultrasonic radar, positioning sensors, pressure sensors, air quality sensors, temperature sensors, etc. Image sensors, lidars, millimeter wave radars, ultrasonic radars, etc. may be used for perception of the surroundings, i.e., to detect dynamic and static objects of the surroundings. Dynamic and static objects may include, for example, static objects such as lane lines, curbs, arrows, signs, trees, buildings, and dynamic objects such as surrounding vehicles, pedestrians, and riders. Positioning sensors are used to enable positioning of a mobile device (e.g., a self-propelled vehicle, robot, etc.) on which the electronic device is located. The positioning sensor may include, for example, an Inertial Measurement Unit (IMU) and a Global Positioning System (GPS) and the like. The pressure sensor may be used to detect seat pressure. The temperature sensor may be used to detect the temperature within the vehicle cabin. The air quality sensor may be used to detect air quality within the vehicle cabin.

The output means 94 may output various information to the outside, which may include, for example, a display, speakers, and a communication network and the connected remote output devices thereof, etc.

Of course, for simplicity, only some of the components of the electronic device 90 relevant to the present disclosure are shown in FIG. 21, with omitting components such as buses, input/output interfaces, etc. In addition, the electronic device 90 may include any other suitable components depending on the particular application.

In some alternative embodiments, an electronic device according to the embodiment of the present disclosure may include a means for rebooting functional components on a system on chip as provided by any one of the above embodiments of the present disclosure.

### Example Computer Program Product and Computer-Readable Storage Medium

In addition to the methods and devices described above, according to embodiments of the present disclosure, there may be also provided a computer program product including computer program instructions which, when executed by a processor, cause the processor to perform the steps in the methods of various embodiments of the present disclosure described in the “Exemplary Methods” section above.

The computer program product may be written with program codes for performing operations according to embodiments of the present disclosure in any combination of one or more programming languages, including object-oriented programming languages, such as Java, C++, etc. and further including conventional procedural programming languages, such as the “C” language or similar programming languages. The program codes may be executed entirely on the user computing device, partially on the user device, as a stand-alone software package, partially on the user computing device, partially on a remote computing device, or entirely on the remote computing device or server.

Furthermore, according to embodiments of the present disclosure, there may also be a computer-readable storage medium having stored thereon computer program instructions which, when executed by a processor, cause the processor to perform the steps in the methods of the various embodiments of the present disclosure described in the “Exemplary Methods” section above.

The computer-readable storage medium may take any combination of one or more readable media. The readable medium may be a readable signal medium or a readable storage medium. The readable storage medium for example but not limited to, an electronic, magnetic, optical, electromagnetic, infrared, or semiconductor system, apparatus, or component, or a combination of any one of the foregoing. More specific examples (a non-exhaustive list) of the readable storage medium include: an electrical connection having one or more wires, a portable computer diskette, a hard disk, a Random-access Memory (RAM), a read-only memory (ROM), an Erasable Programmable Read-only Memory (EPROM or flash memory), an optical fiber, a portable Compact Disk Read-only Memory (CD-ROM), an optical storage component, a magnetic storage component, or any suitable combination thereof.

The general principles of the present disclosure have been described above in connection with specific embodiments, the advantages, advantages, effects, and the like set forth in the present disclosure are merely example and not limiting, and are not to be construed as necessarily referring to the various embodiments of the present disclosure. Furthermore, the particular details disclosed above are for purposes of illustration and description only and are not intended to be limiting, as the present disclosure is not limited to the particular details disclosed above.

Various modifications and alterations to the present disclosure will become apparent to a person skilled in the art without departing from the spirit and scope of the present application. Thus, in case the modifications and variations of the present application are within the scope of the claims and their equivalents, it is intended that the modifications and variations are included in the present disclosure.

What is claimed is:

1. A method for rebooting a functional component on a system on chip, comprising:
performing access isolation on a first bus interface of a first functional component on the system on chip and a shared bus shared by at least two operating systems on the system on chip in response to detecting that a state of the first functional component is a first state;
rebooting the first functional component to transition the first functional component from the first state to a second state; and
performing access dis-isolation on the first bus interface of the first functional component and the shared bus.

2. The method according to claim 1, wherein the performing access isolation on a first bus interface of a first functional component and a shared bus comprises:
disconnecting a transmission path between the first bus interface and the shared bus to prevent an access request of the first functional component from being transmitted to the shared bus; or
terminating forwarding the access request of the first functional component to the shared bus.

3. The method according to claim 1, wherein after the performing access isolation on a first bus interface of a first functional component and a shared bus, the method further comprises:
detecting whether the first bus interface of the first functional component and the shared bus are in an idle state;
wherein the rebooting the first functional component comprises:
rebooting the first functional component in response to detecting that the first bus interface and the shared bus are in the idle state.

4. The method according to claim 1, wherein the performing access isolation on a first bus interface of a first functional component on the system on chip and a shared bus shared by at least two operating systems on the system on chip in response to detecting that a state of the first functional component is a first state comprises:
generating an access isolation enable signal in response to detecting that the state of the first functional component is the first state; and
performing access isolation on the first bus interface of the first functional component and the shared bus based on the access isolation enable signal.

5. The method according to claim 1, wherein the performing access dis-isolation on the first bus interface of the first functional component and the shared bus comprises:
generating an access dis-isolation signal;
connecting a transmission path between the first bus interface and the shared bus based on the access dis-isolation signal to enable the first functional component to access the shared bus again; or
starting forwarding an access request of the first functional component to the shared bus based on the access dis-isolation signal.

6. The method according to claim 1, wherein in a case where it is detected that the state of the first functional component is the first state, the method further comprises:
performing proxy of the first functional component to respond to an access request of the shared bus to the first functional component based on a preset bus protocol.

7. The method according to claim 6, wherein in a case where the state of the first functional component is the second state, the method further comprises:
monitoring a response state of the first functional component to the access request of the shared bus; and
determining that the state of the first functional component is detected as the first state in response to the response state being a timeout.

8. The method according to claim 6, wherein after the rebooting the first functional component, the method further comprises:
generating a state reset signal; and
transitioning from a proxy state to a monitoring state based on the state reset signal, wherein the proxy state is a state of performing proxy of the first functional component to respond to an access request of the shared bus to the first functional component based on a preset bus protocol, and the monitoring state is a state of monitoring a response state of the first functional component to the access request of the shared bus.

9. The method according to claim 1, wherein the rebooting the first functional component to transition the first functional component from the first state to the second state comprises:
transitioning a reset signal of the first functional component from a non-enabled state to an enabled state to transition the first functional component from the first state to a reset state; and
transitioning the reset signal of the first functional component from an enabled state to a non-enabled state to transition the first functional component from the reset state to the second state.

10. A computer readable storage medium storing a computer program thereon, which is used for performing the following steps:
performing access isolation on a first bus interface of a first functional component on the system on chip and a shared bus shared by at least two operating systems on the system on chip in response to detecting that a state of the first functional component is a first state;
rebooting the first functional component to transition the first functional component from the first state to a second state; and
performing access dis-isolation on the first bus interface of the first functional component and the shared bus.

11. The computer readable storage medium according to claim 10, wherein the performing access isolation on a first bus interface of a first functional component and a shared bus comprises:
disconnecting a transmission path between the first bus interface and the shared bus to prevent an access request of the first functional component from being transmitted to the shared bus; or
terminating forwarding the access request of the first functional component to the shared bus.

12. An electronic device, comprising:
a processor;
a memory for storing the processor-executable instruction;
wherein the processor is configured to read the executable instructions from the memory and execute the instructions to implement the following steps:
performing access isolation on a first bus interface of a first functional component on the system on chip and a shared bus shared by at least two operating systems on the system on chip in response to detecting that a state of the first functional component is a first state;
rebooting the first functional component to transition the first functional component from the first state to a second state; and
performing access dis-isolation on the first bus interface of the first functional component and the shared bus.

13. The electronic device according to claim 12, wherein the performing access isolation on a first bus interface of a first functional component and a shared bus comprises:
disconnecting a transmission path between the first bus interface and the shared bus to prevent an access request of the first functional component from being transmitted to the shared bus; or
terminating forwarding the access request of the first functional component to the shared bus.

14. The electronic device according to claim 12, wherein after the performing access isolation on a first bus interface of a first functional component and a shared bus, the method further comprises:
detecting whether the first bus interface of the first functional component and the shared bus are in an idle state;
wherein the rebooting the first functional component comprises:
rebooting the first functional component in response to detecting that the first bus interface and the shared bus are in the idle state.

15. The electronic device according to claim 12, wherein the performing access isolation on a first bus interface of a first functional component on the system on chip and a shared bus shared by at least two operating systems on the system on chip in response to detecting that a state of the first functional component is a first state comprises:
generating an access isolation enable signal in response to detecting that the state of the first functional component is the first state; and
performing access isolation on the first bus interface of the first functional component and the shared bus based on the access isolation enable signal.

16. The electronic device according to claim 12, wherein the performing access dis-isolation on the first bus interface of the first functional component and the shared bus comprises:
generating an access dis-isolation signal;
connecting a transmission path between the first bus interface and the shared bus based on the access dis-isolation signal to enable the first functional component to access the shared bus again; or
starting forwarding an access request of the first functional component to the shared bus based on the access dis-isolation signal.

17. The electronic device according to claim 12, wherein in a case where it is detected that the state of the first functional component is the first state, the method further comprises:
performing proxy of the first functional component to respond to an access request of the shared bus to the first functional component based on a preset bus protocol.

18. The electronic device according to claim 17, wherein in a case where the state of the first functional component is the second state, the method further comprises:
monitoring a response state of the first functional component to the access request of the shared bus; and
determining that the state of the first functional component is detected as the first state in response to the response state being a timeout.

19. The electronic device according to claim 17, wherein after the rebooting the first functional component, the method further comprises:
generating a state reset signal; and
transitioning from a proxy state to a monitoring state based on the state reset signal, wherein the proxy state is a state of performing proxy of the first functional component to respond to an access request of the shared bus to the first functional component based on a preset bus protocol, and the monitoring state is a state of monitoring a response state of the first functional component to the access request of the shared bus.

20. The electronic device according to claim 12, wherein the rebooting the first functional component to transition the first functional component from the first state to the second state comprises:
transitioning a reset signal of the first functional component from a non-enabled state to an enabled state to transition the first functional component from the first state to a reset state; and
transitioning the reset signal of the first functional component from an enabled state to a non-enabled state to transition the first functional component from the reset state to the second state.
